(19) United States
(12) Patent Application Publication
(10) Pub. No.: US 2023/0375670 A1
(43) Pub. Date: Nov. 23, 2023

(54) Production of an Apparatus for Sensing Surroundings for a Motor Vehicle

(71) Applicant: Bayerische Motoren Werke Aktiengesellschaft, Muenchen (DE)

(72) Inventors: Thomas RABL, Muenchen (DE); Maximilian STADLER, Freising (DE)

(21) Appl. No.: 18/030,159

(22) PCT Filed: Nov. 4, 2021
(86) PCT No.: PCT/EP2021/080672

§ 371 Date: Apr. 4, 2023

(30) Foreign Application Priority Data
Nov. 6, 2020 (DE) 10 2020 129 271.6

(51) Int. Cl. G01S 7/481; G01S 17/931; B29C 65/16; B29C 65/00

(52) U.S. Cl. CPC G01S 7/4813; G01S 17/931; B29C 65/1635; B29C 66/24221; B29C 66/73361; B29C 65/1667; B29C 65/1654; B29C 66/836; B29L 2031/3481

(57) ABSTRACT

An apparatus for sensing surroundings of a motor vehicle includes a laser sensing device for sensing surroundings of the motor vehicle, a mount which is fixedly connected to the sensing device and is designed to attach the sensing device to a body of the motor vehicle, and an outer skin component. The mount and the outer skin component each have an end face which faces the other end face. A method is provided for producing a surroundings sensing apparatus by use of laser transmission welding.

### BACKGROUND AND SUMMARY

The invention relates to an apparatus for sensing surroundings of a motor vehicle and a method for producing an apparatus for sensing surroundings of a motor vehicle.

In particular for autonomous driving functions, motor vehicles require laser sensing devices such as LIDAR sensors. They are often arranged on the vehicle front, for example behind a front skirt.

In current vehicles, due to the high demands for avoiding optical distortions in the field of view of the surroundings sensing, either the areas of the LIDAR field of view are cut out from the encasing outer skin components or the surroundings sensing is arranged so that its field of view is not impaired in any case by an outer skin component.

However, since it is often possible for the overall optical image of the motor vehicle to be disturbed by the exposed arrangement of the surroundings sensing, and in particular a LIDAR sensor, it would be desirable to be able to arrange the surroundings sensing behind an outer skin component in such a way that the optical appearance of the motor vehicle is not thus impaired.

The function of the surroundings sensing apparatus, which is LIDAR-based, for example, is not allowed to be impaired over the service life in this case, however. Particular attention is directed here to straightening the optical distortion, which is not permitted to exceed a tolerance of 0.1%. To achieve this requirement using LIDAR, it has to be rigidly attached directly to the outer skin component.

Against this background, it is an object of the invention to improve a method for producing a surroundings sensing apparatus for a motor vehicle and an apparatus for sensing surroundings of a motor vehicle.

This object is achieved by an apparatus and production method having the features of the independent claims. The dependent claims relate to advantageous refinements of the invention.

According to one aspect, an apparatus for sensing surroundings, in particular for distance and velocity monitoring, of a motor vehicle is specified. The apparatus at least includes:
(a) a laser sensing device, in particular having a laser emitter and a sensing sensor system, for example a LIDAR unit. LIDAR units typically used in current motor vehicles have an infrared wavelength of approximately 905 nm (although other wavelengths, which come into consideration with respect to ocular protection and the required functionality, are also conceivable, of course) and a pulse duration of a few nanoseconds (presently approximately 2 ns);
(b) a holder fixedly connected to the sensing device, in particular having or made of a plastic material such as ABS or PC, which is configured to fix the sensing device to a body of the motor vehicle—as much as possible without relative movement play;
(c) an outer skin component, in particular fixedly connected to the holder—for example a front skirt or another panel (for example an emblem panel which bears an insignia of the vehicle manufacturer)—which is transmissive completely or at least in a sensing area (that is to say in an intersection area of the sensing area with the outer skin component) for the wavelength of the laser and/or for laser radiation of every wavelength. The outer skin component can also be a closed radiator grill surface, thus a surface between headlights of the motor vehicle. The outer skin component can be a part which is designed as a component of a vehicle body, such as a body flap, in particular a front flap, a rear flap, or a side door, a fender, a side skirt, or a windowpane.

The outer skin component preferably spans a substantially larger area than the projected area of the holder or the laser sensing device on the outer skin component. For example, the outer skin component is at least two times or three times or four times or five times or six times or seven times or eight times or ten times larger than the external dimensions of the holder or the laser sensing device.

The holder and the outer skin component each have an end face facing toward the other end face, wherein the outer skin component is opaque, i.e., not translucent, in particular in the visible wavelength range.

The holder and the outer skin component are connected to one another fixedly and in particular not detachably nondestructively at the end faces facing toward one another spaced apart from the sensing area.

In this way, the holder and the outer skin component can reliably maintain their position in relation to one another and thus uniform optical conditions for the laser over the service life of the motor vehicle.

The holder is in particular formed using or from a non-laser-transmissive, but laser-meltable material, in particular plastic material or includes such a material at least in the area of its end face.

A sensing area is to be understood in the present case in particular as an area through which laser radiation for surroundings sensing is emitted from the laser toward the surroundings or can propagate from the surroundings toward a sensing sensor system of the apparatus. The sensing area typically has a shape like a cone or truncated cone which originates from the laser emitter.

A sensing window can refer in the present case to an arbitrary plane of section of the sensing area with a component of the surroundings sensing apparatus.

The laser sensing device can preferably include a housing, which is in particular closed or essentially closed. The housing is advantageously mounted on the holder. In particular, the laser sensing device is exclusively mounted on the holder, due to which only the holder defines a location of the laser sensing device, wherein a location of the holder is in turn defined by the nondetachable connection to the outer skin component.

The housing of the laser sensing device can advantageously include a protective panel, which is transmissive for the wavelength of the laser.

The laser sensing device is typically an optoelectronic assembly, which is a supplier component for a vehicle manufacturer, which the vehicle manufacturer acquires as an assembly and then integrates into the vehicle, which takes place according to the present invention by the fastening on the holder.

The holder is advantageously exclusively connected via the outer skin component to the motor vehicle.

Therefore, only the outer skin component determines a location of the holder and thus of the laser sensing device.

The holder can be formed in one piece.

The holder advantageously has a closed circumference having a corresponding end face, which is also formed closed, i.e., ring-shaped, wherein ring-shaped in this context not only comprises a circular ring, but rather any type of closed ring, for example, also a rectangular ring or another polygonal ring or an oval ring.

In this way, the connection between the outer skin component and the holder can be embodied as completely and permanently leak-tight, so that, for example, no contaminants or no liquid, such as water, can penetrate between the outer skin component and the holder.

The holder can enclose the housing of the laser sensing device completely, i.e., in all directions parallel to the outer skin component, so that a location of the laser sensing device is specified accordingly.

According to a further aspect, a method for producing a surroundings sensing apparatus, which is designed in particular according to an embodiment of the invention, is specified, including the following steps:
(1) positioning the end face of the outer skin component and the end face of the holder in relation to one another, and
(2) welding the end faces to one another by means of at least one laser beam, wherein the at least one laser beam is guided through the outer skin component for welding.

That is to say in particular that the connection between the holder and the outer skin component is introduced by means of laser radiation guided through the laser-transparent outer skin component, which is configured in particular to melt the material of the holder on its end face, and possibly via this heat introduction, if it is required for the robustness of the connection, in particular also to melt the material of the outer skin component on its end face.

The invention is based, inter alia, on the consideration that the outer skin component and the holder as such could be connected very reliably in a very simple manner by means of a plastic welded bond, but this would not be possible with regard to technology and economics due to the arrangement of the sensing device and the outer skin component in relation to one another or initially was not reasonable because guiding the laser beam toward potential connecting points was obscured by the outer skin component to be added on.

The invention is now based, inter alia, on the concept of attaching the sensing device having the LIDAR emitter and sensor by means of a holder on a laser-transparent outer skin component rigidly by means of laser beam transmission welding (also referred to as laser transmission welding). The outer skin component consists in this case of a LIDAR-transparent or laser-transparent material, which appears opaque, for example black or gray, in the visible wavelength range. Due to this property, the outer skin component emits the laser beam again during the laser transmission beam welding—after it has been penetrated by the laser beam. In contrast, the material of the holder, to which the LIDAR emitter and sensor are attached, absorbs laser light, at least of the wavelength used.

A material bond can thus be ensured between the outer skin component and the holder of the sensing device.

The outer skin component has, according to one embodiment, at least one protective coating, in particular a laser-transparent protective lacquer, which protects at least the outer skin component from environmental influences.

A relative movement of the connected components in relation to one another is precluded by the connection of the holder to the outer skin component and to the LIDAR emitter and sensor.

According to one embodiment, the connection at the end faces is formed spaced apart in the radial direction (in particular with respect to a longitudinal axis of the holder) from a lateral contour of the holder. A lateral contour is to be understood here in particular as a lateral surface or an entirety of the lateral faces of the holder, independently of whether it is formed rotationally-symmetrical or prismatic on the lateral surface.

This enables a reliably uniform quality of the connecting seam or the connecting points, even upon welding through the outer skin component, in contrast to what would be the case, for example, upon welding at an edge of the lateral surface and the end face of the holder, where the dimensional tolerances of the outer dimensions of the holder would additionally have to be taken into consideration to achieve a uniform quality of the weld seam or the spot weld.

According to one embodiment, the connection is formed by means of at least one molten zone, in particular by means of one or more plastic spot welds and/or weld seams, on the respective end face in the holder and/or in the outer skin component.

A reliable dimensional accuracy and/or low failure rate of the connection is ensured even over the lifetime of the motor vehicle and with sometimes high-frequency alternating load by the material bond.

According to one embodiment, the connection at the end faces is formed completely circumferential around a sensing window, which is defined in particular by a plane of section of the end face with the sensing area.

This enables the sensing area of the laser to be sealed off in the intermediate space between the holder and the outer skin component, in particular against optically active environmental influences such as moisture and/or dirt.

According to one embodiment, the end faces of the holder and of the outer skin component are shaped complementary to one another.

It is then also possible to refer to a common end face of the holder and of the outer skin component. If this end face is curved, for example due to a curvature of the outer skin component, the plane of section of this end face is to be understood as a correspondingly curved surface.

Such a design also minimizes the probability that optically active environmental influences such as moisture and/or dirt become noticeable in the sensing area.

According to one embodiment, the outer skin component is made transmissive for laser radiation (in particular also) in the area of a projection, in particular perpendicular, of the end face of the holder in the outer skin component.

The outer skin component is thus formed so that the laser radiation can be guided through the receptacle component for the connection to the holder without changing its material structure, because no (relevant) heat introduction takes place.

According to one embodiment, the heat introduction takes place due to a superposition of two or more laser beams guided through the outer skin component, in particular in the plane of section or close to the plane of section in the holder.

Due to the superposition of multiple laser beams, the requirement for the laser transparency of the outer skin component can be set lower, because less heat power is guided through the outer skin component at each point in the outer skin component—in comparison to a welded bond executed by a single laser beam.

According to one embodiment, the point of incidence of the laser beam on the end face of the holder and/or a focal point of the superpositioned laser beams is moved over time to achieve a linear weld seam.

Further advantages and possible applications of the invention result from the following description in conjunction with the figures.

### BRIEF DESCRIPTION OF THE DRAWINGS

FIG. 1 shows an apparatus for sensing surroundings according to an exemplary embodiment of the invention in a sectional side view.

FIG. 2 shows the apparatus from FIG. 1 in a sectional view from the front along line of section A-A shown in FIG. 1.

FIG. 3 shows a first exemplary method for producing the apparatus from FIG. 1.

FIG. 4 shows a further exemplary method for producing the apparatus from FIG. 1.

FIG. 5 illustrates a method step of the exemplary method from FIG. 3 on the basis of the sectional illustration of FIG. 2.

### DETAILED DESCRIPTION OF THE DRAWINGS

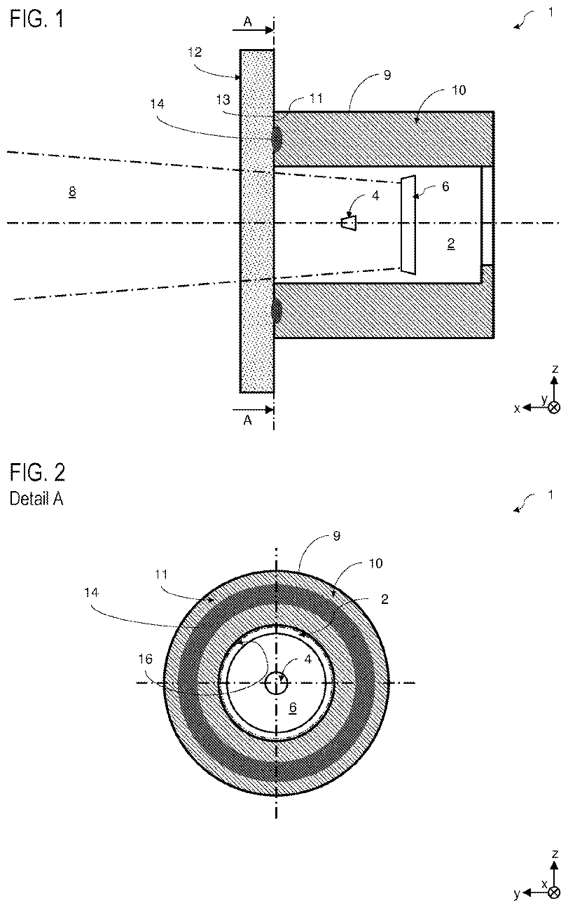

FIG. 1 shows an apparatus 1 for sensing surroundings of a motor vehicle (not otherwise shown), which is configured in particular for distance and velocity monitoring.

The apparatus 1 includes a laser sensing device 2, which is designed as a LIDAR unit, and includes a laser emitter 4 and a sensing sensor system 6. The sensing sensor system 6 has a sensing area 8, which in particular completely includes an emission area of the laser emitter 4. The LIDAR unit advantageously has a housing (not shown) with a protective panel.

Moreover, the apparatus 1 includes a holder 10 fixedly connected (via the housing) to the sensing device 2, which is configured to fix the sensing device 2 on a body (not shown) of the motor vehicle, so that the sensing device 2 is arranged fixed on the body without relevant play. The holder is formed from a non-laser-transmissive, but laser-meltable material, in particular a plastic material, or comprises such a material at least in the area of its end face.

The apparatus 1 furthermore includes an outer skin component 12 fixedly connected to the holder 10, which is completely transmissive to the wavelength of the laser emitter 4 in the exemplary embodiment. The outer skin component 12 is made opaque in particular in the visible wavelength range, i.e., non-translucent, so that it appears black in the exemplary embodiment.

The LIDAR unit is only connected via the holder 10 to the vehicle, so that it is only held by the outer skin component 12. The outer skin component 12 extends over a substantially larger area than the holder 10, so that it is not recognizable from the outside at which point the LIDAR unit is located or which section of the outer skin component 12 is used as the radome for the LIDAR unit.

In exemplary embodiments which are not shown, the outer skin component 12 can also be made transmissive to laser radiation of every wavelength and/or can be made laser transmissive at all only in the sensing area 8.

In any case, the holder 10 has a ring-shaped end face 11, and the outer skin component 12 has an end face 13. The two end faces 11 and 13 face toward one another and are formed congruent in such a way that they abut one another.

By means of a circumferential plastic weld seam 14, which forms a closed circular ring (cf. also FIG. 2), the holder 10 and the outer skin component 12 are materially bonded to one another at the end faces 11 and 13 facing toward one another. The weld seam 14 in the exemplary embodiment is arranged spaced apart radially outward at the end faces 11 and 13 from the sensing area 8 and is arranged spaced apart radially inward from a lateral contour 9 of the holder 10.

In this way, the holder 10 and the outer skin component 12 are connected fixedly and not detachably nondestructively by the weld seam 14, which is accommodated completely in the interior of the plastic bodies pressing against one another of the holder 10 and the outer skin component 12.

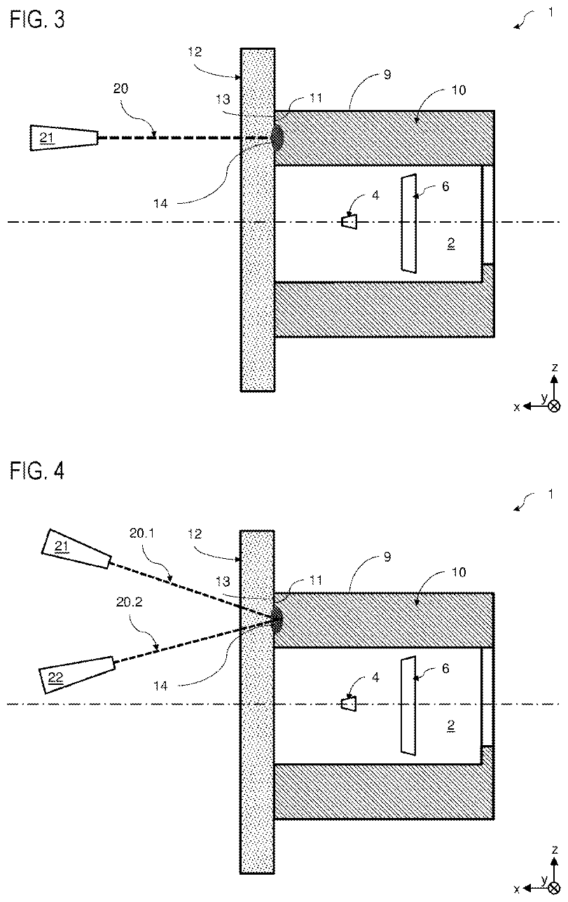

This optimum positioning of the connecting point can be achieved by means of a production method according to one of the exemplary embodiments from FIG. 3 or 4, in that the laser radiation used for joining is applied through the outer skin component 12 to the connecting point.

In this way, the holder and the outer skin component can maintain their position in relation to one another and thus uniform optical conditions for the laser reliably over the service life of the motor vehicle.

The weld seam 14 is formed completely circumferential around a sensing window 16, which is defined by a plane of section of the end face with the sensing area 8, at the end faces 11 and 13. An intermediate space between the holder 10 and the outer skin component 12 is thus sealed off against moisture and dirt.

In sectional view A-A of FIG. 2, especially the circumferential weld seam 14 having its spacing in the radial direction from the sensing window 16 radially outward and the lateral contour 9 of the holder 10 radially inward can be recognized well.

A first exemplary method for producing the apparatus 1 is shown in FIG. 3.

The holder 10 and the outer skin component 12 are shown already positioned in relation to one another with end faces 11 and 13 pressing against one another.

By means of a laser welding head 21, the end faces 11 and 13 are welded to one another by means of a single laser beam 20.

The laser beam is guided through the outer skin component 12 for welding, wherein no heat development takes place there due to the laser-transmissive design of the outer skin component 12, but only upon incidence of the laser beam 20 on the end face 11 of the holder 10. This is because the holder 10 is not formed from a laser-transmissive plastic.

The connection between the holder 10 and the outer skin component 12 is thus introduced through the laser-transparent outer skin component 12 by means of the laser beam 20, in that the material of the holder 10 is melted on its end face 11, and via this heat introduction the material of the outer skin component 12 is also melted on its end face 13.

A second exemplary method for producing the apparatus 1 is shown in FIG. 4. The second exemplary method differs from that according to FIG. 3 in particular in that the heat introduction into the holder 10 takes place on the end face 11 due to a superposition of two laser beams 20.1 and 20.2, which are guided separately through the outer skin component.

Due to the superposition of the two laser beams 20.1 and 20.2—originating from welding heads 21 and 22—the heat introduction can be delimited locally very accurately to the superposition point of the two beams 20 and 21.2.

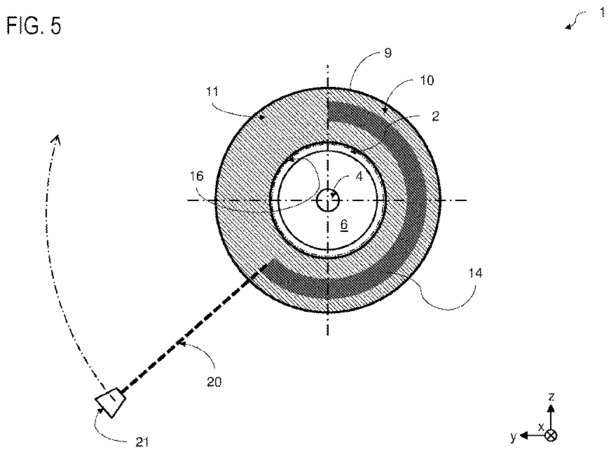

FIG. 5 illustrates for the first exemplary method according to FIG. 3 how the circumferential weld seam 14 from FIG. 2 is successively introduced by moving or pivoting the welding head 21. Of course, a similar procedure is also provided in the second exemplary method according to FIG. 4, wherein then the welding heads 21 and 22 are pivoted or moved in such a way that the superposition point of the two laser beams 20.1 and 20.2 travels accordingly.

### LIST OF REFERENCE NUMERALS

1 surroundings sensing apparatus
2 laser sensing device
4 laser emitter
6 sensing sensor system
8 sensing area
9 lateral contour of the holder
10 holder
11 end face of the holder
12 outer skin component
13 end face of the outer skin component
14 plastic weld seam
16 sensing window
20 laser beam
21, 22 laser welding heads

1.-15. (canceled)

16. An apparatus for sensing surroundings of a motor vehicle, comprising:
a laser sensing device;
a holder fixedly connected to the laser sensing device and configured to fix the sensing device to a body of the motor vehicle;
an outer skin component transmissive to a wavelength of the laser sensing device and/or to laser radiation of every wavelength completely or at least in a sensing area, wherein
the holder and the outer skin component each have one end face that faces toward one another, and
the holder and the outer skin component are fixedly connected to one another at the end faces facing toward one another.

17. The apparatus according to claim 16, wherein
the fixed connection at the end faces is formed spaced apart in a radial direction from a lateral contour of the holder.

18. The apparatus according to claim 16, wherein
the fixed connection is formed by at least one molten zone on a respective end face in the holder and/or in the outer skin component.

19. The apparatus according to claim 18, wherein
the at least one molten zone comprises one or more plastic spot welds and/or weld seams.

20. The apparatus according to claim 16, wherein
the fixed connection at the end faces is formed completely circumferential around a sensing window.

21. The apparatus according to claim 16, wherein
the end faces of the holder and the outer skin component are shaped complementary to one another.

22. The apparatus according to claim 16, wherein
the outer skin component is also transmissive to laser radiation in an area of a projection of the end face of the holder in the outer skin component.

23. The apparatus according to claim 16, wherein
the laser sensing device comprises a housing, which is essentially closed, and
the housing is mounted on the holder of the laser sensing device.

24. The apparatus according to claim 16, wherein
the holder is only connected via the outer skin component to the motor vehicle.

25. The apparatus according to claim 24, wherein
the laser sensing device is only fastened via the holder on the motor vehicle.

26. The apparatus according to claim 16, wherein
the laser sensing device is only fastened via the holder on the motor vehicle.

27. A method for producing a surroundings sensing apparatus, comprising:
positioning an end face of an outer skin component of the apparatus and an end face of a holder of the apparatus in relation to one another, wherein the apparatus comprises:
a laser sensing device;
the holder fixedly connected to the laser sensing device and configured to fix the sensing device to a body of the motor vehicle;
the outer skin component transmissive to a wavelength of the laser sensing device and/or to laser radiation of every wavelength completely or at least in a sensing area;
welding the end faces to one another via at least one laser beam, wherein the at least one laser beam is guided through the outer skin component for said welding.

28. The method according to claim 27, wherein
heat introduction takes place due to a superposition of two or more laser beams guided through the outer skin component, in the plane of section or close to the plane of section in the holder.

29. The method according to claim 27, wherein
a point of incidence of the laser beam on the end face of the holder is moved over time.

30. The method according to claim 29, wherein
a point of incidence of the laser beam on the end face of the holder and/or a focal point of the super-positioned laser beams is moved over time.

31. The method according to claim 27, further comprising:
mounting a housing, which is closed, of the laser sensing device on the holder.

32. The method according to claim 27, wherein
the holder is connected only via the outer skin component to the motor vehicle.

33. The method according to claim 27, wherein
the laser sensing device is fastened only via the holder on the motor vehicle.
